(19) United States
(12) Patent Application Publication
(10) Pub. No.: US 2025/0245316 A1
(43) Pub. Date: Jul. 31, 2025

(54) REDUCING SYSTEM ATTACK SURFACE BY SELECTIVELY RESTRICTING FUNCTIONALITY

(71) Applicant: International Business Machines Corporation, Armonk, NY (US)

(72) Inventors: Troy E. Fisher, Phoenixville, PA (US); James McConnell, Ottawa (CA); Andrew Low, Sittsville (CA)

(21) Appl. No.: 18/422,773

(22) Filed: Jan. 25, 2024

(51) Int. Cl. G06F 21/52

(52) U.S. Cl. CPC G06F 21/52; G06F 2221/034

(57) ABSTRACT

A computer-implemented method, according to one approach, includes: initiating, by an operating system and based at least in part on information received from an application, a single task mode. The single task mode is configured to: suspend all programs and subsystems running on a computer, and subsequently reactivate a subset of the suspended programs and subsystems. The subset of the suspended programs and subsystems that are reactivated enables completion of a sensitive task. A dedicated single task mode scheduler also schedules the sensitive task using the reactivated subset of the programs and subsystems, and the sensitive task is completed. Furthermore, the single task mode is ended by the operating system based at least in part on additional information received from the application.

### BACKGROUND

The present invention relates to system security measures, and more specifically, this invention relates to restricting functionality to improve system security.

More aspects of daily life have become virtualized and data storage complexity has increased. This in turn has increased the importance of implementing effective cybersecurity measures to protect sensitive information such as passwords and other information used during authentication to guard an increasing amount of information for users.

Modern computers typically run an operating system allowing many concurrent processes to run. Users enjoy being able to rapidly move between many active applications or allow others to operate in the background while they focus on another. When a user performs a sensitive task with a given bit of software (say a password manager), if malicious software (such as a keylogger) is also running, there is a security risk that the password may be stolen. It is in these situations where the many processes can become a liability. Conversely, running less code reduces security risk.

### SUMMARY

A computer-implemented method (CIM), according to one approach, includes: initiating, by an operating system and based at least in part on information received from an application, a single task mode. The single task mode is configured to: suspend all programs and subsystems running on a computer, and subsequently reactivate a subset of the suspended programs and subsystems. The subset of the suspended programs and subsystems that are reactivated enables completion of a sensitive task. A dedicated single task mode scheduler also schedules the sensitive task using the reactivated subset of the programs and subsystems, and the sensitive task is completed. Furthermore, the single task mode is ended by the operating system based at least in part on additional information received from the application.

A computer program product (CPP), according to another approach, includes: a set of one or more computer-readable storage media. The CPP further includes program instructions that are collectively stored in the set of one or more storage media. Moreover, the program instructions are for causing a processor set to perform the foregoing CIM.

A computer system (CS), according to yet another approach, includes: a processor set, and a set of one or more computer-readable storage media. The CS further includes program instructions that are collectively stored in the set of one or more storage media. The program instructions are for causing the processor set to perform the foregoing CIM.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-processes for one of the operations in the method of FIG. 3A, in accordance with one approach.

FIG. 3C is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for securing the performance of sensitive tasks. Accordingly, implementations herein are able to selectively control the attack surface of a system. Some approaches may thereby be used to establish a secure environment in which superfluous programs and subsystems are disabled and only the programs and/or subsystems that are directly correlated with a given task are enabled to reduce the effective attack surface for an environment, e.g., as will be described in further detail below.

In one general approach, a CIM includes: initiating, by an operating system and based at least in part on information received from an application, a single task mode. The single task mode is configured to: suspend all programs and subsystems running on a computer, and subsequently reactivate a subset of the suspended programs and subsystems. The subset of the suspended programs and subsystems that are reactivated enables completion of a sensitive task. A dedicated single task mode scheduler also schedules the sensitive task using the reactivated subset of the programs and subsystems, and the sensitive task is completed. Furthermore, the single task mode is ended by the operating system based at least in part on additional information received from the application.

In another general approach, a CPP includes: a set of one or more computer-readable storage media. The CPP further includes program instructions that are collectively stored in the set of one or more storage media. Moreover, the program instructions are for causing a processor set to perform the foregoing CIM.

In yet another general approach, a CS includes: a processor set, and a set of one or more computer-readable storage media. The CS further includes program instructions that are collectively stored in the set of one or more storage media. The program instructions are for causing the processor set to perform the foregoing CIM.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved task security code at block 150 for establishing a secure environment in which superfluous programs and subsystems are disabled and only the programs and/or subsystems that are directly correlated with a given task are enabled to reduce the effective attack surface for an environment. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

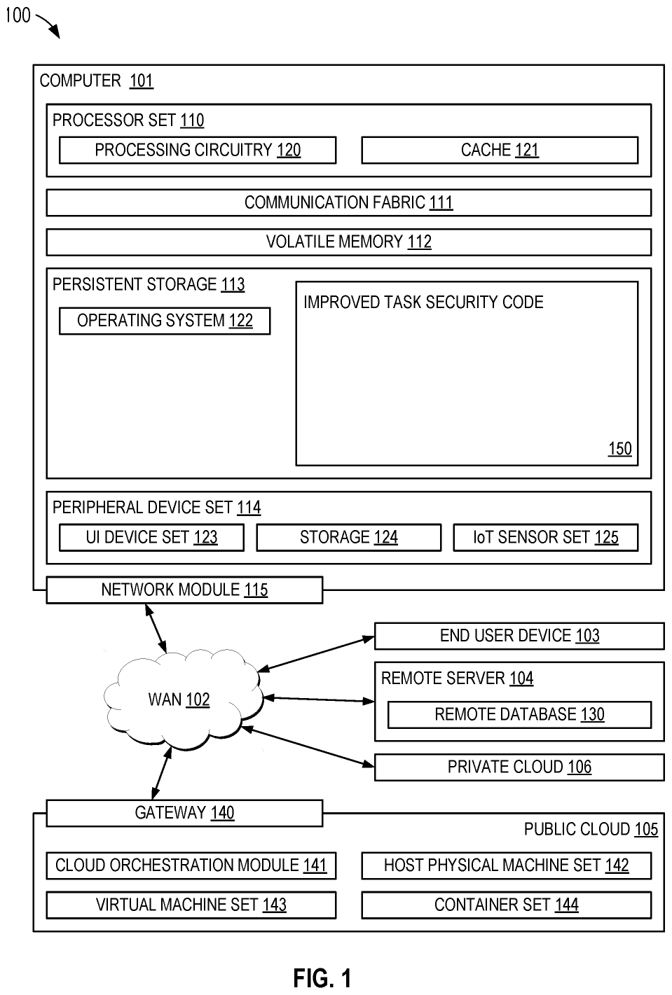

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, more aspects of daily life have become virtualized and data storage complexity has increased. This in turn has increased the importance of implementing effective cybersecurity measures to protect sensitive information such as passwords and other information used during authentication to protect an increasing amount of information for users. Accordingly, password managers have been developed to store and manage passwords for local applications or online services such as web applications, online shops, social media, etc.

While these password managers may also implement security features to protect the passwords stored therein, the passwords are often prone to exposure when being accessed and/or submitted. In other words, passwords are still vulnerable to exposure while being accessed, in addition to after they have been removed from a password manager. According to an example, passwords are at risk of exposure while being entered in a security check. For instance, malicious code (e.g., keylogger malware) may be unknowingly installed on a user's computer and used to steal a password from the clipboard or as it is being entered into a prompt field.

It follows that users have been at risk of inadvertently exposing their passwords despite using password managers and other security measures. While some attempts have been made to address this security issue, they are either incomplete or place an undue burden on the end user that discourages use of the technology. For instance, some attempts provide ‘application sandboxes’ that restrict the visibility of a given application. However, in order for applications to be useful, often they need to access shared resources (e.g., such as a file system). Thus, even sandboxed applications may be compromised and used as an access point for information that is accessible to the shared resources. These attempts also often involve complicated and cumbersome procedures, which lead users to intentionally avoid implementing them in the interest of efficiency and ease of use at the expense of system security.

In sharp contrast to these conventional shortcomings, implementations included herein are able to protect users against inadvertently exposing sensitive information while using computing devices, e.g., such as a computer. This is also achieved while allowing the computing devices to function normally under typical usage, and enter a restricted mode of operation while performing certain tasks.

The restricted mode of operation improves computer security by restricting the visibility of software components (e.g., applications), as well as limiting background processes and network communications that are permitted. Seamlessly implementing these restrictions while performing sensitive tasks effectively minimizes the danger that security risks like compromised applications pose. It should be noted that, as used herein, the term “sensitive task” may refer to any type of task (e.g., procedure) that involves data for which access to the data is to be restricted and/or controlled in some way. For instance, a sensitive task may include any process that is susceptible to cyberattacks, e.g., such as a password authentication (e.g., verification) process.

Approaches herein are thereby able to provide a more secure way to complete sensitive tasks on a computer by removing the threat vector posed by other programs running on that computer. In other words, approaches herein reduce the available attack surfaces of corresponding systems by selectively restricting activity that exposes the system to attacks. Moreover, these approaches may be applied across a number of different scenarios, e.g., as will be described in further detail below.

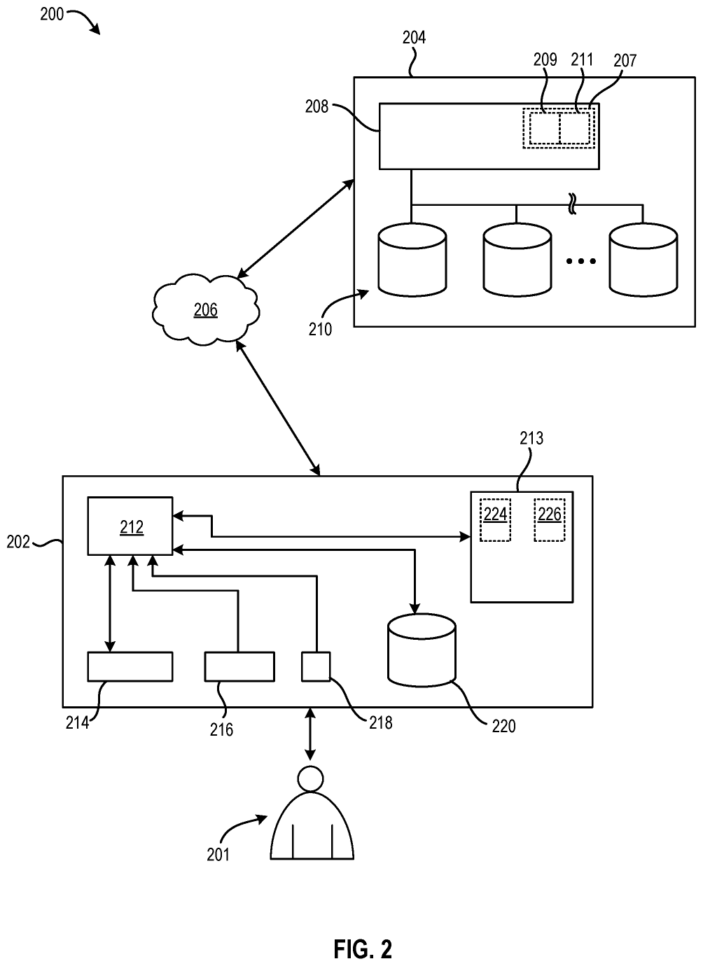

Referring now to FIG. 2, a compute system 200 is illustrated in accordance with one approach. As an option, the present compute system 200 may be implemented in conjunction with features from any other approach listed herein, such as those described with reference to the other FIGS., such as FIG. 1. However, such compute system 200 and others presented herein may be used in various applications and/or in permutations which may or may not be specifically described in the illustrative approaches listed herein. Further, the compute system 200 presented herein may be used in any desired environment. Thus FIG. 2 (and the other FIGS.) may be deemed to include any possible permutation.

As shown, compute system 200 includes a local computer module 202 that is connected to a remote compute location 204 (e.g., remote server) over a network 206. As a result, any desired information, data, commands, instructions, responses, requests, etc. may be sent between local computer module 202 and remote compute location 204. The network 206 may be of any type, e.g., depending on the desired approach. For instance, in some approaches the network 206 is a WAN, e.g., such as the Internet. However, an illustrative list of other network types which network 206 may implement includes, but is not limited to, a LAN, a PSTN, a SAN, an internal telephone network, etc. Accordingly, module 202 and location 204 are able to communicate with each other regardless of the amount of separation which exists therebetween, e.g., despite being positioned at different geographical locations.

It should also be noted that computer module 202 and remote compute location 204 may be connected differently depending on the approach. For example, the computer module 202 and remote compute location 204 may be located relatively close to each other and connected by a wired connection, e.g., a cable, a fiber-optic link, a wire, etc., or any other type of connection which would be apparent to one skilled in the art after reading the present description.

Remote compute location 204 includes a processor 208 coupled to memory 210. The processor 208 further includes a scheduler module 207 that may be used to assign resources at the remote compute location 204 to perform tasks (e.g., operations). The scheduler module 207 further includes a normal scheduler 209 and a dedicated single task mode scheduler 211. The normal scheduler 209 may control the process of assigning resources (e.g., compute resources, memory capacity, etc.) at the remote compute location 204 during normal operation or normal mode. In other words, the normal scheduler 209 may control what operations are performed by the remote compute location 204 while in normal mode. However, the dedicated single task mode scheduler 211 may gain control of assigning resources at the remote compute location 204 while in a single task mode. In other words, the dedicated single task mode scheduler 211 may control what operations may potentially be performed, as well as what operations are ultimately performed, by the remote compute location 204 (e.g., the system) while in single task mode.

It should be noted that “normal operation” or “normal mode” as used herein is intended to refer to situations during which programs and/or subsystems are operating (e.g., at the remote compute location 204) without any significant changes from an intended order (e.g., progression). A system in a normal mode or following normal operation may thereby be able to meet objectives without any impact to performance. Moreover, a “single task mode” as used herein is intended to refer to situations during which programs and/or subsystems function according to a specific mode of operation (e.g., following a predetermined progression). A system in single task mode may thereby be actively prevented from performing certain types of operations, while other types of operations are permitted. According to some approaches, certain physical components may be kept in a low-power mode (e.g., sleep mode) such that they are unable to perform any operations and/or communicate with other components in the system, while other physical components in the system that are correlated with predetermined types of operations may be kept in a powered (e.g., operational) state such that they are able to perform at least a portion of the predetermined types of operations. In one example, which is in no way intended to be limiting, a wireless antenna may intentionally be kept in a low-power state to prevent network connectivity during a single task mode, while physical cache memory components may intentionally be powered and kept in an operational state.

The processor 208 may thereby control how the remote compute location 204 is able to operate. Similarly, the local computer module 202 includes a central processor 212 that is connected to a scheduler module 213 that may be used to assign resources at the local computer module 202 to perform tasks (e.g., operations). The scheduler module 213 further includes a normal scheduler 224 and a dedicated single task mode scheduler 226. The normal scheduler 224 may control the process of assigning resources (e.g., compute resources, memory capacity, etc.) at the local computer module 202 during normal operation or normal mode. In other words, the normal scheduler 224 may control what operations are performed by the local computer module 202 while in normal mode. However, the dedicated single task mode scheduler 226 may gain control of assigning resources at the local computer module 202 while in a single task mode. In other words, the dedicated single task mode scheduler 226 may control what operations may potentially be performed, as well as what operations are ultimately performed, by the single task mode scheduler 226 while in single task mode.

It follows that although the scheduler module 213 is shown as being a separate component from the central processor 212, it may control the flow of operations that are performed at the local computer module 202, along with which of the components therein are operational. Any of the approaches described above with respect to scheduler module 207 may thereby be implemented at the local computer module 202 by the scheduler module 213, e.g., as would be appreciated by one skilled in the art after reading the present description. It follows that in some approaches, the scheduler module 213 may be implemented in the central processor 212.

Returning to computer module 202, a central processor 212 is coupled to a number of components that form a computer interface for a user 201. For instance, the central processor 212 is coupled to a display screen 214, a keyboard 216, and a computer mouse 218. The central processor 212 may thereby be configured to receive inputs from the keyboard 216 and computer mouse 218 as entered by the user 201. These inputs typically correspond to information presented on the display screen 214 in coordination with an operating system running on the computer module 202 while the entries were received. Moreover, the inputs received from the keyboard 216 and computer mouse 218 may impact the information shown on display screen 214, data stored in memory 220, status of an operating system being implemented by processor 212, steps taken by the operating system running on the computer module 202, etc.

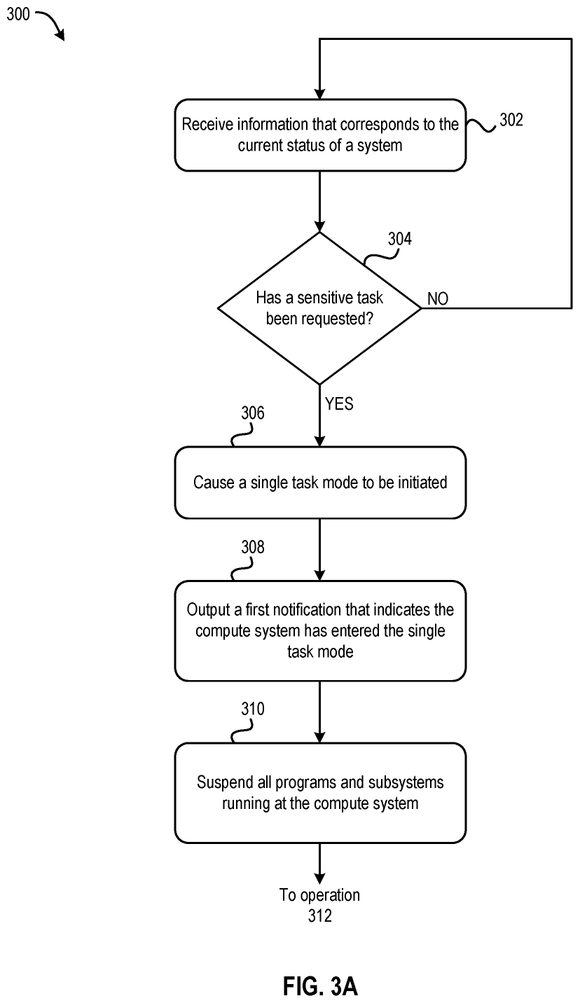

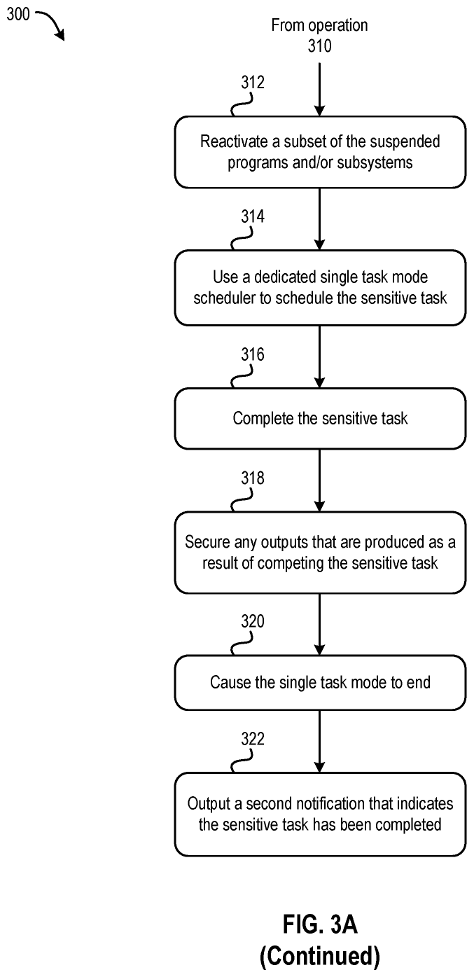

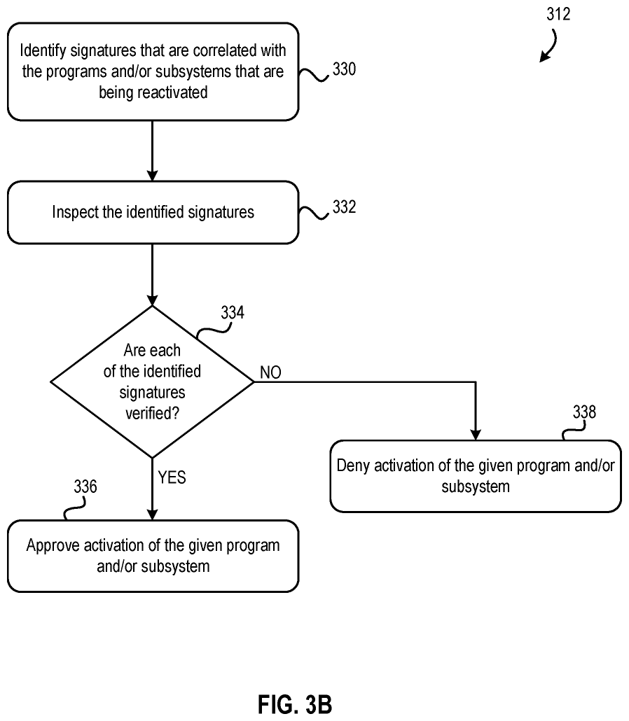

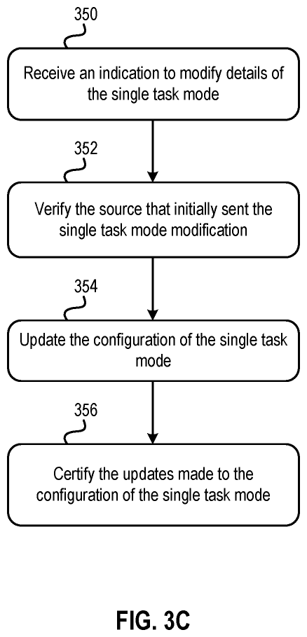

It should also be noted that the display screen 214, the keyboard 216, and the computer mouse 218 are each coupled directly to the processor 212 in the present implementation. Accordingly, inputs received from the keyboard 216 and/or computer mouse 218 may be evaluated before being implemented in the operating system and/or shown on display screen 214. For example, the central processor 212 and/or scheduler module 213 may perform any one or more of the operations described below in method 300 of FIG. 3A in order to selectively control the attack surface of an environment, e.g., as will be described in further detail below.

Referring now to FIG. 3A, a method 300 for selectively controlling the attack surface of a system is illustrated in accordance with one approach. One or more of the operations in method 300 may thereby be used to establish a secure environment in which superfluous programs and subsystems are disabled and only the programs and/or subsystems that are directly correlated with a desired function (e.g., task) are enabled to reduce the effective attack surface for an environment.

The method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment using known techniques and/or techniques that would become readily apparent to one skilled in the art upon reading the present disclosure. For example, method 300 may be performed by a controller (e.g., see central processor 212 along with scheduler module 213, and/or processor 208, of FIG. 2) in response to receiving instructions from a user to perform a sensitive task, in response to a predetermined application being initiated or run, etc., or in other situations that are susceptible to cyberattacks. In other approaches, the method 300 may be partially or entirely performed by a processor, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3A, operation 302 includes receiving information that corresponds to the current status of a system. For instance, the information received in operation 302 may include sensor readings, outputs produced by running applications, user entries, network traffic, etc. While the system is operating normally (e.g., within allowed tolerances), the information that is received conveys this status of the system. However, in some approaches the information received in operation 302 indicates that a sensitive task is active. In other words, the information may identify that a sensitive task is being performed or planned to be performed.

As noted above, the term “sensitive task” as used herein may refer to any type of task (e.g., procedure) that involves data for which access to the data is to be restricted and/or controlled in some way. For instance, a sensitive task may include any process that is susceptible to cyberattacks, e.g., such as a password authentication process on a computer system. Sensitive tasks may also include procedures that simply involve (e.g., reference) sensitive data, which may include confidential data, data that is to remain within an organization and not shared outside the organization, data that is not to be made available to the public, data that a user wishes to keep private, data that is subject to a higher standard of care as a result of applicable legislation and/or corporate policies (e.g., data associated with children under 13 years of age as specified by the Children's Online Privacy Protection Act), data that is provided confidentially to another user or entity, etc. In some approaches, certain computing tasks and/or applications are designated by a user, application developer, system administrator, etc., as “sensitive tasks.” When these sensitive tasks are to be carried out, the computer system enters into a “single-task” state for the duration of the task.

It follows that the type(s) of information, source(s) of the information, amount of information, etc., may vary depending on the approach. According to an exemplary approach, which is in no way intended to be limiting, operation 302 includes an application sending information that is received by a dedicated application program interface (API). The information sent by the application may thereby notify the dedicated API of a sensitive task being initiated. In response to receiving the notifying information, the dedicated API may trigger an operating system to enter a single task mode.

Method 300 advances from operation 302 to operation 304. There, operation 304 includes examining the received information and determining whether a sensitive task has been requested (e.g., the sensitive task has been “initiated”). In response to determining the received information does not indicate a sensitive task has been requested (e.g., the sensitive task is not “active”), method 300 returns to operation 302, e.g., such that additional information may be received and evaluated. It follows that operations 302 and 304 may be repeatedly performed in an iterative fashion to dynamically monitor system performance over time.

However, method 300 advances from operation 304 to operation 306 in response to determining that the received information does indicate a sensitive task is active. There, operation 306 includes causing a single task mode to be initiated. In some approaches, the single task mode may be initiated by sending one or more instructions to an operating system running on a compute system that is configured to perform at least some of the operations in method 300.

As noted above, initiating the single task mode causes programs and/or subsystems to function according to a specific mode of operation (e.g., following a predetermined progression). A compute system that enters single task mode may thereby be actively prevented from performing certain types of operations, while other types of operations are permitted. According to some approaches, certain physical components may be kept in a low-power mode (e.g., sleep mode) such that they are unable to perform any operations and/or communicate with other components in the system, thereby intentionally limiting system capabilities in the interest of reducing the attack surface of the system while performing sensitive tasks. However, other physical components in the system that are correlated with performing predetermined types of sensitive tasks may be kept in a powered (e.g., operational) state such that they remain operational even while performing the sensitive tasks. In one example, which is in no way intended to be limiting, a wireless antenna may intentionally be kept in a low-power state to prevent network connectivity during a single task mode, while physical cache memory components may intentionally be powered and kept in an operational state.

In some approaches, the process of entering the single task mode may involve verifying one or more security features. The security features may assist with authenticating attempts to enter the single task mode as well as the specific results of entering the single task mode. According to one example, a dedicated single task mode scheduler is used to verify a cryptographic signature appended to the specific configurations of the single task mode. In situations where the cryptographic signature is verified as matching a trusted copy of the signature, the system may be allowed to enter the dedicated single task mode. However, in situations where the cryptographic signature is not verified or is identified as a fraudulent signature attempt, the system may be denied from entering the dedicated single task mode for a predetermined amount of time, until a predetermined condition is met, until a new cryptographic signature is established and verified, etc.

In some approaches, the process of entering the single task mode may involve logically and/or physically activating hardware that is otherwise inaccessible outside the single task mode. According to an example, an external storage device which is only logically connected to a remainder of a system while in single task mode. The external storage device may include a storage volume which is encrypted, only being mounted and decrypted while the system is in single task mode. This secures a portion of the computing environment while in this single task mode. Thus, while approaches herein involve deactivating various portions of a system to increase security while in single task mode, some approaches may only enable certain parts of a system while in single task mode.

Method 300 further advances from operation 306 to operation 308 in response to the single task mode being initiated. There, operation 308 includes outputting a first notification that indicates the compute system has entered the single task mode. In some approaches, the first notification is sent to a user that interfaces with the operating system of the compute system. The first notification may indicate the type of sensitive task being performed, system functionality that has been suspended as a result of entering the single task mode, system functionality that remains operational while in the single task mode, etc.

From operation 308, method 300 advances to operation 310. There, operation 310 includes suspending all programs and subsystems running at the compute system that has been placed in single task mode. Once again, initiating the single task mode causes programs and/or subsystems to function according to a specific mode of operation (e.g., following a predetermined progression). A compute system that enters single task mode may thereby be actively prevented from performing certain types of operations, while other types of operations are permitted. Thus, by initially suspending all programs and subsystems that are installed on a compute system, operation 310 is able to effectively minimize the attack surface of the system, allowing for specific functions (e.g., physical and/or logical components) to be reactivated in order to selectively control the capabilities of the compute system as well as the attack surface of the compute system while performing sensitive tasks.

Accordingly, operation 312 further includes reactivating a subset of the suspended programs and/or subsystems. Again, the subset of programs and/or subsystems that are reactivated effectively controls the functional capabilities of the compute system. According to some approaches, physical components may be suspended (e.g., deactivated) by restricting a power supply provided to the components. In other words, the physical components may be kept in a low-power mode (e.g., sleep mode) such that they are unable to perform any operations and/or communicate with other components in the system. However, certain physical components in the compute system that are correlated with performing select types of sensitive tasks may be kept in a powered (e.g., operational) state depending on the type of sensitive task identified in operation 304. Again, this intentionally limits compute system capabilities in the interest of reducing the attack surface of the system while performing sensitive tasks.

Referring momentarily to FIG. 3B, exemplary sub-operations of reactivating a subset of the suspended programs and subsystems are illustrated in accordance with one approach. It follows that one or more of the sub-operations in FIG. 3B may be used to perform operation 312 of FIG. 3A. Moreover, one or more of the sub-operations in FIG. 3B may be repeated for each program and/or subsystem being reactivated from a suspended state. Thus, although certain ones of the sub-operations in FIG. 3B are described in the context of a “given one” of the programs and/or subsystems that are being reactivated, the approaches herein may be applied to any of the programs and/or subsystems that are being reactivated. Furthermore, the sub-operations of FIG. 3B are illustrated in accordance with one approach which is in no way intended to limit the invention.

As shown, sub-operation 330 includes identifying signatures that are correlated with the programs and/or subsystems that are being reactivated. In other words, sub-operation 330 includes determining a signature that corresponds to a program or subsystem being reactivated from a suspended state. According to some approaches, the signatures may be metadata that is appended to the base program or subsystem. In other approaches, the signatures may be cryptographic hash values that are stored in a specific container located in the base program or subsystem. In still other approaches, a signature request may be sent directly to a user (e.g., system administrator, author of the base program or subsystem, etc.).

Sub-operation 332 further includes inspecting the signatures identified in sub-operation 330, while sub-operation 334 includes determining whether each of the signatures are verified. In other words, sub-operation 334 includes determining whether each of the signatures can be trusted. This may be performed in some approaches by comparing each of the signatures identified in sub-operation 330, and inspected in sub-operation 332, to a set of known (e.g., trusted) copies of active signatures. In other words, a signature that is appended to an application may be extracted and compared against a lookup table of current signatures to determine whether a match exists.

In response to determining that the identified signature can be verified (e.g., trusted), the flowchart proceeds from sub-operation 334 to sub-operation 336. Sub-operation 336 includes approving activation of the given program and/or subsystem being evaluated. Verifying a signature of each program and/or subsystem before activation while in the single task mode adds another layer of security by avoiding situations where an existing program and/or application is replaced with a compromised version. Accordingly, the flowchart proceeds from sub-operation 334 to sub-operation 338 in response to determining that the identified signature cannot be verified (e.g., trusted). There, sub-operation 338 includes denying activation of the given program and/or subsystem being evaluated. In addition to denying activation of the program and/or subsystem identified as not having a valid signature, additional steps may be taken to avoid security issues moving forward. For example, a warning may be sent to a user, a replacement signature may be requested, the application and/or subsystem may remain in a suspended state for a predetermined amount of time, etc.

Returning now to FIG. 3A, method 300 advances from operation 312 to operation 314 in response to reactivating desired ones of the suspended programs and/or subsystems to enable completion of a sensitive task. There, operation 314 includes using a dedicated single task mode scheduler to schedule the sensitive task. In other words, operation 314 includes causing the sensitive task to be performed by the programs and/or subsystems reactivated in operation 312. In some approaches, the dedicated single task mode scheduler (e.g., see dedicated single task mode scheduler 211 of FIG. 2) may be given control of assigning resources at a compute system to perform tasks while the compute system is in a single task mode. In other words, the dedicated single task mode scheduler may control what operations are able to be performed, as well as what operations are ultimately performed, while in single task mode. This control may be acquired from a normal scheduler (e.g., see normal scheduler 209 of FIG. 2) while the compute system is in single task mode.

Proceeding now to operation 316, the sensitive task is completed. Operation 318 further includes securing any outputs that are produced as a result of competing the sensitive task. In other words, operation 318 includes protecting the security and integrity of information, data, results, etc. that may be output as a biproduct of performing the sensitive task. According to an example, which is in no way intended to be limiting, the sensitive task may involve retrieving a password from a secure environment (e.g., a protected password vault). Operation 318 may thereby include encrypting the password before it is saved to a clipboard, sent over a network connection, stored in a secondary location, etc. In some approaches, the output(s) may be secured using asymmetric key and/or public key cryptography. This conserves the integrity of the information produced as a result of completing the sensitive task.

From operation 318, method 300 advances to operation 320. There, operation 320 includes causing the single task mode to end in response to the sensitive task being completed. In other words, operation 320 includes causing the compute system to exit the single task mode and return to a normal mode of operation in response to determining that the sensitive task has been completed. According to some approaches, the process of causing the compute system to exit the single task mode and return to a normal mode of operation includes causing schedule control to be returned from a dedicated single task mode scheduler to a normal scheduler. As noted above, a dedicated single task mode scheduler gains control of assigning resources at a location while it is in a single task mode. The dedicated single task mode scheduler is thereby able to control what operations may potentially be performed, as well as what operations are ultimately performed while in single task mode. However, reverting control back to a normal scheduler allows for resources to be assigned without imposing restrictions based on what programs and/or subsystems have been temporarily suspended, e.g., as would be appreciated by one skilled in the art after reading the present description.

In addition to causing schedule control to be returned to the normal scheduler, any programs and/or subsystems that were suspended in operation 310 are reactivated. This allows the system to return to normal operation and utilize any desired programs and/or subsystems. However, it should be noted that in some approaches, specific programs and/or subsystems may be intentionally kept in a suspended state. For example, a program identified as having been compromised (e.g., a cryptographic signature verification fails) may be kept in a suspended state until an administrator is able to inspect the details of the program and repair any flaws.

From operation 320, method 300 advances to operation 322. There, operation 322 includes outputting a second notification that indicates the sensitive task has been completed. In some approaches, the second notification is sent to a user that interfaces with the operating system of the compute system. The second notification may indicate the type of sensitive task that has been completed, system functionality that has been restored as a result of exiting the single task mode, system functionality that remains operational while in the single task mode, etc.

As noted above, the process of entering the single task mode may involve verifying one or more security features in some approaches. The security features may assist with authenticating attempts to enter the single task mode as well as the specific results of entering the single task mode. According to one example, a dedicated single task mode scheduler is used to verify a cryptographic signature appended to the specific configurations of the single task mode. Security features may also be used to verify updates that are made to the single task mode itself. In other words, the specific programs and/or subsystems that are suspended as a result of entering the single task mode, the specific programs and/or subsystems that are reactivated while in the single task mode, and other details of the single task mode may be adjusted over time based on user preferences, installed applications, past performance, identified security threats, etc.

Looking now to FIG. 3C, exemplary sub-operations of verifying updates that are made to the single task mode are illustrated in accordance with one approach. It follows that one or more of the sub-operations in FIG. 3C may be performed in the background to monitor changes made to the single task mode and ensure the system as a whole remains protected. Moreover, one or more of the sub-operations in FIG. 3C may be repeated for each update that is made to the single task mode. Furthermore, the sub-operations of FIG. 3C are illustrated in accordance with one approach which is in no way intended to limit the invention.

As shown, sub-operation 350 includes receiving an indication to modify details of the single task mode. In other words, one or more instructions, requests, commands, prompts, user input, etc., that involve making changes to how the single task mode is implemented and/or how it impacts performance of the remainder of the system. In some approaches, sub-operation 350 includes receiving one or more instructions to adjust the programs and/or subsystems that are suspended in response to initiating the single task mode. In other approaches, the one or more instructions may involve adjusting the select programs and/or subsystems that are reactivated while in the single task mode. For example, a password login procedure may be updated to implement encryption. This update may trigger a change to the single task mode such that an encryption module is reactivated from a suspended state while in the single task mode.

In response to receiving the indication to modify aspects of the single task mode, sub-operation 352 includes verifying the source that initially sent the single task mode modification. Verifying the source may involve inspecting the source and determining whether it is authorized to make changes to the single task mode. This may be performed by authenticating a cryptographic signature, answering one or more security based questions, etc., or any other way of verifying the identity of the source.

In response to determining that the modification request has been received from a verified source, the flowchart proceeds to sub-operation 354. There, sub-operation 354 includes updating the configuration of the single task mode. The updates to the single task mode are preferably based at least in part on inputs received from a user. For example, the updates may correspond to one or more instructions received from a user.

Furthermore, sub-operation 356 includes certifying the updates made to the configuration of the single task mode. The updates may be certified in some approaches by cryptographically signing the updates with a signature that corresponds to the user that initiated the updates. The cryptographic signature may thereby indicate the corresponding updates were made by a particular user, at a particular time, at a particular location, etc. In some approaches, the updates are assigned a key that is stored in memory and used to verify authenticity of the current version of the single task mode before being initiated. Accordingly, it should be noted that the dedicated single task mode scheduler as described herein may be configured to verify the cryptographic signature that is correlated with a particular set of updates made to the configuration of the single task mode. It follows that functions will not be scheduled unless it has a signed binary and the signature can be validated. For example, approaches that have alternate input methods installed (e.g., such as an emoji keyboard or other third party keyboard), will not be allowed to function, while built-in input methods will be enabled.

It follows that approaches herein involve selectively activating a single task mode. The single task mode may be triggered by applications to change the scheduling of the operating system to a restricted set of processes. As noted above, while in the single task mode, only a limited set of processes are active, thereby reducing the risk of malicious software being able to access sensitive information. This restricted mode of operation can be seamlessly entered and exited without undue interruption in workflow to the end user. Moreover, by running radically less code during the single task mode, approaches herein have reduced the attack surface significantly.

According to an in-use example, which is in no way intended to be limiting, an application may call for a sensitive task (the “single task”) to be completed. Accordingly, a signal is sent to a single task mode API to initiate the single task mode as defined in a pre-defined profile. With respect to the present description, a “profile” includes a set of processes which are allowed to operate (are reactivated from a suspended state) during single task mode. The operating system thereby initiates a “sleep mode”, sending all programs and/or subsystems into a low-power or suspended mode.

The operating system wakes (e.g., reactivates) only the part(s) of the system defined by the profile to support the requested sensitive task. For instance, a graphics module and input devices may be reactivated from a suspended state. The operating system enables a dedicated single task mode scheduler which will only schedule the single user-level application defined in the profile, along with only the minimum system processes necessary to support the sensitive task. Functions will not be scheduled unless they have a signed binary and the signature can be validated.

The user is notified that single task mode is enabled, and the user completes the requested sensitive task. If any output is generated as a result of performing the sensitive task, it may be further protected (e.g., using asymmetric key and/or public key cryptography) to prevent further attacks.

In response to completing the sensitive task, the application signals to the single task mode API that the task has been completed and regular operations may resume. In response, the operating system switches control back to a normal scheduler and reactivates a remainder of the system, thereby resuming the normal operating state.

According to another in-use example which is again in no way intended to be limiting, a password manager application running on a computer may be infected with a keylogger. The keylogger may be running as an unknown standalone process, or the keylogger may have replaced or modified an existing system driver. Thus, in situations where a user retrieves a system password from a password vault, this involves launching a password manager application, typing in the master password in order to unlock access to the stored passwords, and finally accessing the desired password. Typically, the user will copy the system password from the vault, and then later paste it into a desired application. During any phase of this process, the keylogger may be able to steal either the master password or the system password.

As part of single task mode, the task of using the password manager is preferably identified in advance as a high-integrity or “sensitive” task. When the user launches the password manager, the single task mode API is signaled per the process outlined in the approaches herein. The operating system causes all programs and subsystems to enter a sleep mode, before waking only the subsystems associated with completing the task, so long as all executables involved pass the signature verification.

At this point, the single task scheduler will execute only the password manager, display subsystem and input subsystem as these are the components associated with completing the sensitive task in the present in-use example. Thus, if the keylogger was running as a standalone process, it would be kept in a suspended state and would not be able to run because the single task scheduler would refuse to schedule it. Even if the keylogger had modified or replaced the system keyboard driver, the driver would not pass the signature verification step, and the single task scheduler would not run the driver. Instead, the system would alert the user and fail, falling back to the signed (e.g., trusted) version of the driver.

Thus, the keylogger is unable to execute and is completely blocked from monitoring the user. The user is notified that single task mode is enabled and they may now safely type in their master password and copy the necessary system password from the password manager. Upon retrieving the system password from the password manager, the user than closes the password manager application, which causes that application to signal to the single task mode API that the task has been successfully completed and normal operations may resume. Scheduling control is returned to the normal (e.g., standard) scheduler, and normal processing resumes. The keylogger is thereby unable to steal the master password to unlock the password vault. In this way, the security incident caused by the keylogger has been averted.

Moreover, a customizable application profile can be used to allow applications to update the single task mode processing procedures. The profile can be cryptographically signed to ensure that it has not been tampered with. The single task mode scheduler may thereby validate the profile signature and refuse to enable single task mode if the signature cannot be validated.

In yet another in-use example, which is again in no way intended to be limiting, a cloud-based model may involve a cloud service that operates with all user data encrypted at rest. However, in response to entering a single task mode, a portion of the user data may be decrypted for a window of time to perform a ‘sensitive’ task (e.g., operation). In some approaches, the data being protected (kept encrypted) at a cloud location is a master encryption key. This master encryption key is thereby protected using encryption, and itself is able to serve as a master key that mints new secondary keys that are used to secure or verify things. The process implemented in response to entering the single task mode may include: fetching a code to decrypt a master key; using the code to decrypt the master key; use the master key to generate a new signing key; re-encrypting the master key and scrubbing any intermediary information; and retaining the new signing key. If one or more of these operations are performed at a cloud location in some approaches, the master key remains encrypted at all times from the viewpoint of any concurrent task. Thus, there is no chance for any malicious code to look at the decrypted master key or the generated codes, as other (e.g., non-verified) operations cannot be executed at all during the sensitive task.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method (CIM), comprising:
initiating, by an operating system and based at least in part on information received from an application, a single task mode, wherein the single task mode is configured to:
suspend all programs and subsystems running on a computer,
reactivate a subset of the suspended programs and subsystems, wherein the subset enables completion of a sensitive task,
cause a dedicated single task mode scheduler to schedule the sensitive task using the reactivated subset of the programs and subsystems, and
cause the sensitive task to be completed; and
ending, by the operating system and based at least in part on additional information received from the application, the single task mode.

2. The CIM of claim 1, wherein the ending of the single task mode includes:
causing schedule control to be returned from the dedicated single task mode scheduler to a normal scheduler; and
reactivating any ones of the programs and/or subsystems that remain suspended.

3. The CIM of claim 1, wherein the sensitive task is susceptible to cyberattack, wherein the sensitive task includes a password authentication.

4. The CIM of claim 1, wherein the single task mode is further configured to:
send a first notification to a user in response to the single task mode being initiated; and
sending a second notification to the user in response to the sensitive task being completed.

5. The CIM of claim 1, wherein the reactivating of the subset of the suspended programs and subsystems includes, for each of the programs and/or subsystems in the subset:
identifying a signature correlated with a given one of the programs and/or subsystems in the subset; and
verifying the identified signature.

6. The CIM of claim 5, wherein the reactivating of the subset of the suspended programs and subsystems further includes:
in response to determining the identified signature cannot be verified, denying activation of the given one of the programs and/or subsystems in the subset.

7. The CIM of claim 5, wherein the reactivating of the subset of the suspended programs and subsystems further includes:
in response to verifying the identified signature, approving activation of the given one of the programs and/or subsystems in the subset.

8. The CIM of claim 1, wherein the single task mode is further configured to:
encrypt an output produced in response to the sensitive task being completed.

9. The CIM of claim 1, further comprising:
updating a configuration of the single task mode based at least in part on inputs received from a user; and
cryptographically signing the updates to the configuration of the single task mode,
wherein the dedicated single task mode scheduler is configured to verify a cryptographic signature created by the cryptographical signing.

10. A computer program product (CPP), comprising:
a set of one or more computer-readable storage media; and
program instructions, collectively stored in the set of one or more storage media, for causing a processor set to perform the following computer operations:
initiate, based at least in part on information received from an application, a single task mode, wherein the single task mode is configured to:
suspend all programs and subsystems running on a computer,
reactivate a subset of the suspended programs and subsystems, wherein the subset enables completion of a sensitive task,
cause a dedicated single task mode scheduler to schedule the sensitive task using the reactivated subset of the programs and subsystems, and
cause the sensitive task to be completed; and
end, based at least in part on additional information received from the application, the single task mode.

11. The CPP of claim 10, wherein the ending of the single task mode includes:
causing schedule control to be returned from the dedicated single task mode scheduler to a normal scheduler; and
reactivating any ones of the programs and/or subsystems that remain suspended.

12. The CPP of claim 10, wherein the sensitive task is susceptible to cyberattack, wherein the sensitive task includes a password authentication.

13. The CPP of claim 10, wherein the single task mode is further configured to:
send a first notification to a user in response to the single task mode being initiated; and
sending a second notification to the user in response to the sensitive task being completed.

14. The CPP of claim 10, wherein the reactivating of the subset of the suspended programs and subsystems includes, for each of the programs and/or subsystems in the subset:
identifying a signature correlated with a given one of the programs and/or subsystems in the subset; and
verifying the identified signature.

15. The CPP of claim 14, wherein the reactivating of the subset of the suspended programs and subsystems further includes:
in response to determining the identified signature cannot be verified, denying activation of the given one of the programs and/or subsystems in the subset.

16. The CPP of claim 14, wherein the reactivating of the subset of the suspended programs and subsystems further includes:
in response to verifying the identified signature, approving activation of the given one of the programs and/or subsystems in the subset.

17. The CPP of claim 10, wherein the single task mode is further configured to:
encrypt an output produced in response to the sensitive task being completed.

18. The CPP of claim 10, wherein the program instructions are for further causing the processor set to perform the following computer operations:
update a configuration of the single task mode based at least in part on inputs received from a user; and
cryptographically sign the updates to the configuration of the single task mode,
wherein the dedicated single task mode scheduler is configured to verify a cryptographic signature created by the cryptographical signing.

19. A computer system (CS), comprising:
a processor set;
a set of one or more computer-readable storage media;
program instructions, collectively stored in the set of one or more storage media, for causing the processor set to perform the following computer operations:
in response to a single task mode being initiated based at least in part on information received from an application:
suspending all programs and subsystems running on a computer;
reactivating a subset of the suspended programs and subsystems, wherein the subset enables completion of a sensitive task;
using a dedicated single task mode scheduler to schedule the sensitive task based at least in part on the reactivated subset of the programs and subsystems,
completing the sensitive task; and
causing the single task mode to end in response to the sensitive task being completed.

20. The CS of claim 19, wherein the program instructions are for further causing the processor set to perform the following computer operations:
update a configuration of the single task mode based at least in part on inputs received from a user; and
cryptographically sign the updates to the configuration of the single task mode,
wherein the dedicated single task mode scheduler is configured to verify a cryptographic signature created by the cryptographical signing.
